(19) United States
(12) Patent Application Publication
(10) Pub. No.: US 2012/0084669 A1
(43) Pub. Date: Apr. 5, 2012

(54) DYNAMIC GROUP GENERATION

(75) Inventors: ERIKA C. FLINT, Los Gatos, CA (US); JOSEPH MOULTON JAQUINTA, Medford, MA (US); ARTI ABHAY KALE, Westminster, CO (US); SHAKIL MANZOOR KHAN, Highland Mills, NY (US); MARK EDWARD PODLASECK, Kent, NY (US); SUPARNA SINHA ROY, Round Rock, TX (US); PROJJWAL SAHA, New Delhi (IN)

(73) Assignee: INTERNATIONAL BUSINESS MACHINES CORPORATION, Armonk, NY (US)

(21) Appl. No.: 12/894,372

(22) Filed: Sep. 30, 2010

(51) Int. Cl. G06F 17/30; G06F 3/01

(52) U.S. Cl. 715/753; 707/803; 707/E17.005

(57) ABSTRACT

A pre-defined set of similarity parameters associated with a plurality of clients in a virtual environment, including at least one non-spatial dynamic parameter, is identified. The identified pre-defined set of similarity parameters is processed using at least one tool from a pre-defined set of analysis tools. A group is created within the plurality of clients using the identified at least one non-spatial dynamic parameter. A plurality of group characteristics associated with the group is generated using the processing of the identified pre-defined set of similarity parameters. A user interface is provided to at least one client from the group for communication in response to the generated plurality of group characteristics, wherein the user interface is used for at least one of intra-group communication and communication external to the group.

### BACKGROUND

Promulgation of the Internet has spawned interests in developing virtual reality systems and virtual environments. Virtual reality systems typically allow many clients to participate and interact with each other in a shared three-dimensional (3D) virtual environment. Virtual environments, such as virtual world environments, are increasingly being seen as a tool to facilitate better collaboration among employees within an enterprise. The 3D look and feel, which is similar to face to face interaction in a real world scenario, is preferably desired for better communication.

### BRIEF SUMMARY

Embodiments of the invention are directed to a method, system and computer program product for generating a group of users (hereinafter also referred to as clients) within a plurality of clients in a virtual environment. Accordingly, embodiments of the invention identify a pre-defined set of similarity parameters associated with a plurality of clients in a virtual environment including at least one non-spatial dynamic parameter and creating the group within the plurality of clients using the identified at least one non-spatial dynamic parameter. The at least one non-spatial dynamic parameter is selected from a set comprising at least one from a plurality of dynamic behavior parameters, a plurality of dynamic sensor data parameters, and a plurality of dynamic message data parameters. The pre-defined set of similarity parameters further includes at least one of a plurality of spatial dynamic parameters, a plurality of spatial historical parameters and a plurality of non-spatial historical parameters. The plurality of spatial dynamic parameters includes at least one of geographical coordinates, and geographical proximity with respect to a reference, whereas the plurality of non-spatial historical parameters comprises at least one from a plurality of client profile parameters, a plurality of client interest parameters, and a plurality of client website usage parameters. Yet further embodiments modify the group in response to a change in at least one parameter from a plurality of spatial dynamic parameters and the at least one non-spatial dynamic parameter. Embodiments further process the identified pre-defined set of similarity parameters using at least one from a pre-defined set of analysis tools comprising data mining, statistics, machine learning and artificial intelligence and generate a plurality of group characteristics associated with the group using the processing of the identified pre-defined set of similarity parameters. Yet further embodiments of the invention provide a user interface to at least one client from the group, in response to the generated plurality of group characteristics, wherein the user interface is used for at least one of intra-group communication and communication external to the group.

### BRIEF DESCRIPTION OF THE DRAWINGS

Embodiments of the invention are described below, by way of example only, with reference to the following schematic drawings, where:

FIG. 1 shows a schematic of generating a group of users within a plurality of clients in a virtual environment as disclosed in an exemplary embodiment of the invention;

FIG. 2 depicts a flow chart for a method of generating a group of users within a plurality of clients in a virtual environment as disclosed in an exemplary embodiment of the invention; and

FIG. 3 shows an exemplary schematic of a computer system on which the exemplary embodiments of FIG. 1 and FIG. 2 may be implemented.

### DETAILED DESCRIPTION

Embodiments of the invention are directed to a method, a system and a computer program product for generating a group of users within a plurality of clients in a virtual environment. In a real world environment, pushing contextual content to a user is a domain that is well established in marketing/advertising. Conventionally it could be achieved by using keywords used in a mailing, or by determining past browsing habits of a user.

Conventionally, clauses such as ‘Users of similar interest have also purchased these objects’, are also seen based on static analysis of a user's website visits history and generated interests. Futuristic visualizations, such as seen in the move ‘Minority Report’, posit a universal identification mechanism and demonstrate targeted real-world advertising at individuals based on proximity. Analyzing and pushing contextual information to a dynamic group of avatars is therefore a domain that can add value to existing collaborative capabilities of a virtual world. There are analogous practices in the virtual world interface as well. The current state of the art allows targeted advertising to avatars in the virtual world using user interfaces like billboards, based on an avatar's profile. The keywords used by the avatar in-world can also serve as a context for flashing advertisements. Typically, contextual advertisements are flashed to all community members and the advertisements are based on interests of existing communities. In all these above methods, the audience of the content is mainly static in nature. Some methods push contextual information to a single user based on the user's current/past habits. Some other methods are based on a pre-defined group's characteristics such that any one who is seen exhibiting some of the pre-defined characteristics of the group of users (need to be specific here) are shown the group's related content. Still further, some tools use predefined groups to push the contextual information of interest associated with the group.

Conventionally, group formation uses physical or geographical proximity and hence spatial parameters to determine groups. The target audience, as a dynamic group, is generated when in-world avatars from diverse profiles/backgrounds gather in a particular region, for example a geographical region. Embodiments of the invention generate a target audience that is a dynamic group based on non-spatial dynamic parameters. The information is dynamically computed by the back-end data mining and correlation engines (detailed in the implementation) based on dynamic and historical information of the group members. Embodiments of the invention also describe coupling of messaging information with present (dynamic) and past (historical) data to more completely signify the context. This information combination, when presented to group members, may add value and help to filter irrelevant messages to the group.

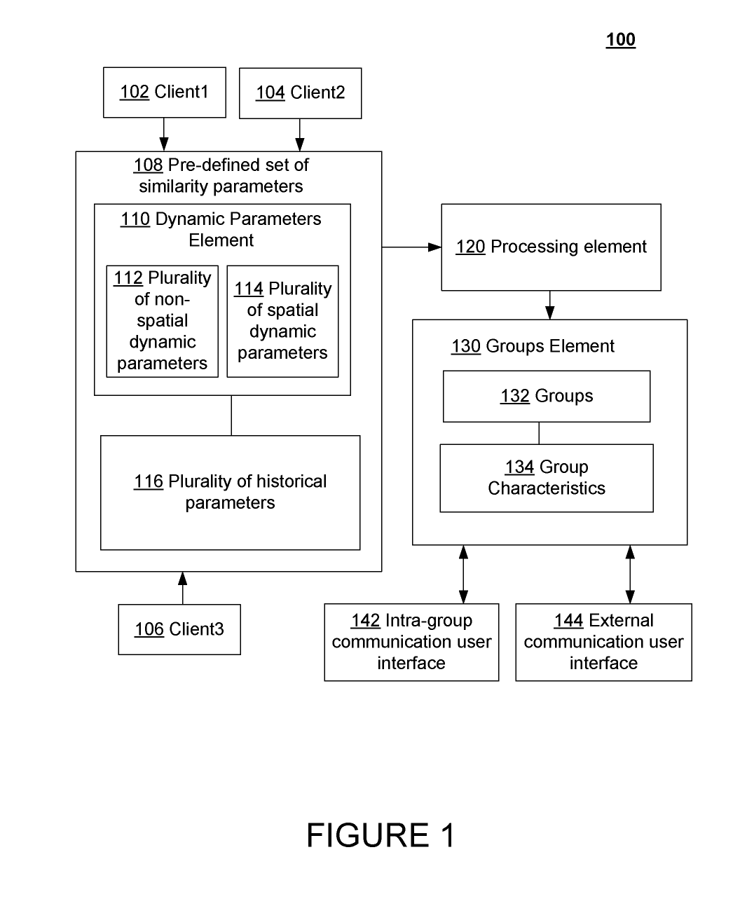

FIG. 1 shows a schematic 100 of generating a group within a plurality of clients in a virtual environment as disclosed in an exemplary embodiment of the invention. Schematic 100 includes exemplary clients in a virtual environment indicated by Client1 102, Client2 104, and Client3 106. Embodiments of the invention provide dynamic messaging for a dynamic group of users in a virtual world, based on real time and historical data of the group members. In one embodiment, the group of users is dynamically transformed based on individual activity of an exemplary plurality of clients, such as client1 102, client2 104 and client3 106. Multiple clients log into the virtual world or virtual environment and collaborate. Schematic 100 further includes a pre-defined set of similarity parameters 108, a processing element 120, a group element 130 and two exemplary user interfaces: intra-group communication user interface 142 and external communication user interface 144, discussed below.

The pre-defined set of similarity parameters 108 further comprises a dynamic parameters element 110 and historical parameters 116. Dynamic parameters element 110, in one embodiment, further comprises virtual world behavior and real world sensor data associated with the avatars or clients, in the form of live feeds. Dynamic parameters element 110 further includes non-spatial dynamic parameters 112 and spatial dynamic parameters 114. Non-spatial dynamic parameters 112 comprise real world profile information, interests, work patterns, and/or web site usage behavior, for example, of all or multiple clients from client1 102, client2 104 and client3 106. Other examples of non-spatial dynamic parameters include keywords of user chat sessions, individual privacy settings of clients, instant messaging statuses, calendar schedules of clients, images from a webcam, audio or transcript from a microphone, and desktop images. Spatial dynamic parameters 114 may comprise at least one of geographical coordinates, and geographical proximity with respect to a reference, for example. The exemplary reference may be a shop or a point of interest in the virtual environment. Other examples of spatial dynamic parameters are current interest patterns such as entering into a particular business oriented region, or touching objects which could reveal their interest like “Fashion clothes”. The plurality of non-spatial dynamic parameters 112 can be verified for accuracy and relevancy with corresponding historical parameters 116 previously stored. The historical parameters may include many of the same parameters described in the spatial and non-spatial dynamic parameters, except that they are stored over time and are not real time or near-real time.

Processing element 120 uses both sets of parameters, from the dynamic parameters element 110 and the historical parameters 116, to analyze and process the parameters using selected analytics tools, and to generate groups element 130. Groups element 130 includes group 132 and associated group characteristics 134. Exemplary group characteristics may include principal components, a mathematical combination of multiple parameters, or a statistical combination of multiple parameters. Analysis of such integrated data for the group members from the set of clients can identify and generate certain common areas of interests, behaviors, social denominations for these clients.

Presenting the combination of information and context valid for groups 132 in groups element 130 can be used to facilitate a more meaningful collaboration among the group members. An intra-group communication user interface 142 is adapted to facilitate communication between multiple clients of the group. An external communication user interface 144 is adapted to facilitate communication of one or more clients within the group with entities external-to-the-group. Communication is meant to be two way and hence information may be pushed out or pulled in. One exemplary use of such external communication user interface 144 may be advertising to group 132 in the virtual environment.

An exemplary communication of intra-group communication user interface 142 is illustrated below

“Avatar3 is an expert on web applications security. Based on your current interaction with Avatar2 and your past mails in this domain, would you like to interact with Avatar3? This information may be extracted based on real time (dynamic) and past (historical) behavior of virtual environment clients. Another example of communication of intra-group communication user interface 142 is:

“Avatar4 has bookmarks in the same domain as yours. You both seem to have similar interests! Would you like to interact?” Such analyses facilitate easy expert detection and are suited for enhanced collaboration among employees within an enterprise. Yet another example of communication of intra-group communication user interface 142 is:

“Avatar1 is a frequent traveler to Chicago. Since you will be travelling there next week (as detected by your calendar), it would be a good idea to get in touch with Avatar1”.

An example of external communication user interface 144 is in the area of advertising. In an exemplary mode, if a common area of interest is identified for avatars (clients) in a particular region, relevant advertisements can be flashed to them in a user interface, such as, for example, a relevant advertisement could be flashed on billboards that would be of interest of everyone in the region. This mechanism can be used to pull new customers from the virtual world. An exemplary advertisement targeted to an avatar can read as:

“5 avatars near your vicinity have been regular customers of “ABC” restaurant. Would you like to visit the restaurant ABC?”

External communication user interface 144 can be made intuitive in the virtual world and the implementation can be in the form of a bubble that will be used over every avatar or client. The bubble could flash contextual information for every avatar so that the information will be viewed by other avatars present in the vicinity, for example. This also adds value, both from a collaboration and a marketing point of view, as all avatars in the vicinity can view contextual information of others, which can help in attracting the attention of members of the virtual environment.

External communication user interface 144 can have 3D spatial dimension added to it. In an exemplary mode, some loosely coupled bubbles can move towards/away from the avatar. This would indicate that the direction of the avatar has been established in the vicinity from where the connection/commonality is. This can also indicate whether the distance between the avatars is increasing/decreasing with time. In yet another embodiment, the avatar or client can configure the context of interest for the information/advertisements. The client can configure the privacy settings as well such as:

“expose my contextual information to:
all avatars in the virtual world.”;
avatars within a fixed region.”;
a few named avatars.”; or
no one.”.

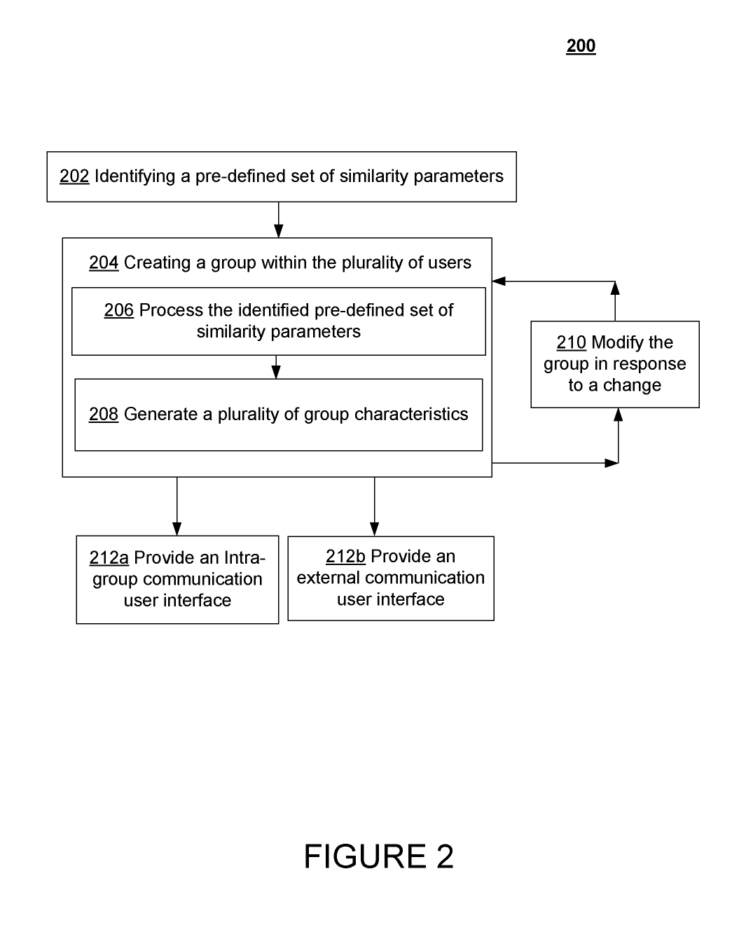

FIG. 2 shows a flow chart 200 for generating a group of users within a plurality of clients in a virtual environment as disclosed in an exemplary embodiment of the invention. In step 202, a pre-defined set of similarity parameters associated with the clients in a virtual environment, including an at least one non-spatial dynamic parameter, is identified. Step 204 shows creating a group of users within the plurality of clients using the identified at least one non-spatial dynamic parameter, which includes the at least one of dynamic behavior parameters, dynamic sensor data parameters, and dynamic message data parameters. The pre-defined set of similarity parameters further includes at least one of spatial dynamic parameters, spatial historical parameters and non-spatial historical parameters. The spatial dynamic parameters includes at least one of geographical coordinates, and geographical proximity with respect to a reference, and the plurality of non-spatial historical parameters includes at least one from a plurality of client profile parameters, a plurality of client interest parameters, and a plurality of client website usage parameters.

Step 206 depicts processing the identified pre-defined set of similarity parameters using at least one from a pre-defined set of analysis tools comprising data mining, statistics, machine learning and artificial intelligence. Step 208 shows generating a plurality of group characteristics associated with the group using the processing of the identified pre-defined set of similarity parameters. Exemplary plurality of group characteristics may include principal components, a mathematical combination of multiple parameters, or a statistical combination of multiple parameters. It should be noted here that the step of creating a group with client 204 includes the steps 206 and 208.

Step 210 depicts modifying the group of users if there is a change in at least one parameter from a plurality of spatial dynamic parameters and the at least one non-spatial dynamic parameter. Following Step 204 the outcome is either Step 212a and Step 212b. Step 212a shows providing a user interface to at least one client from the group for intra-group communication in response to the generated plurality of group characteristics, while Step 212b depicts providing a user interface to at least one client from the group for communication external to the group in response to the generated plurality of group characteristics

In an exemplary embodiment of the invention, the identified group may be subdivided into subgroups using the group characteristics that are generated. Communication, directed either within the group or external to the group, may derive from the sub-groups identified within the group. An exemplary group may be of clients interested in “tourism related information”. Sub-groups may be identified from within the “tourism related information” group using the same steps (Step 204, Step 206 and Step 208) as above, in which case the sub-groups may be, for example, “clients interested in only Asia specific tourism” and “clients interested in Europe specific tourism”. Intra-group communication will tend to be more useful and meaningful for the clients included in multiple sub-groups. It is also clear that any Asia specific tourism related advertisements, such as, but not limited to, Asia hotel specials, Asia car rentals etc. will be more appropriately targeted for clients in the “Asia specific tourism” sub-group within the “tourism related information” group.

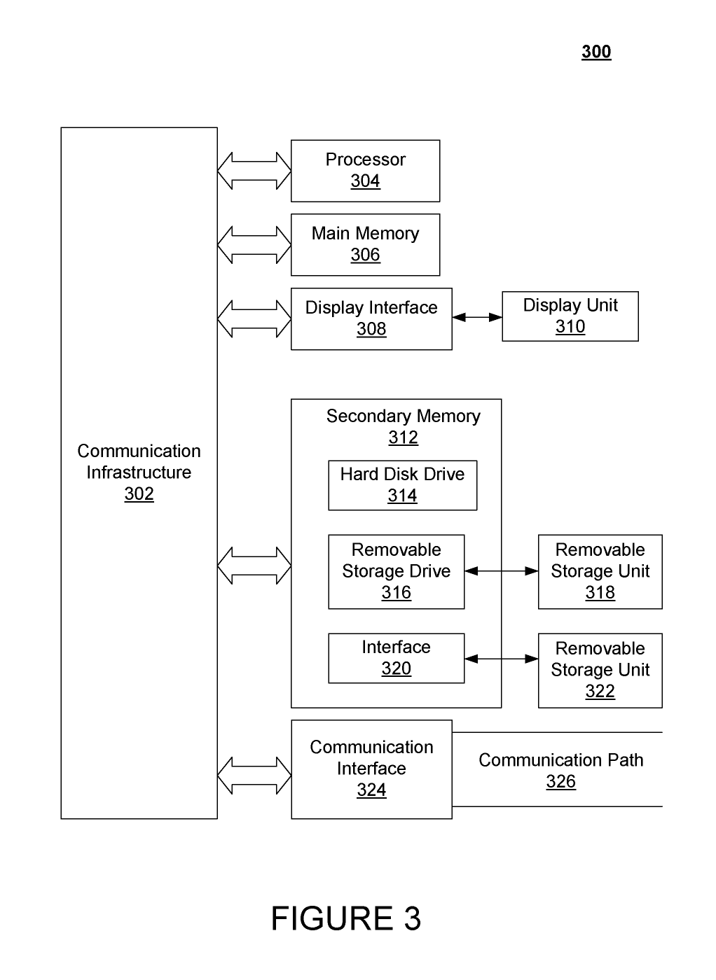

FIG. 3 is a block diagram of an exemplary computer system 300 that can be used for implementing various embodiments of the present invention. In some embodiments, the computer system 300 can be used as a system described in FIG. 1. In some embodiments, the computer system 300 can be used to perform the steps described in FIG. 2. The Computer system 300 includes a processor 304. It should be understood that although FIG. 3 illustrates a single processor, one skilled in the art would appreciate that more than one processor can be included as needed. The processor 304 is connected to a communication infrastructure 302 (for example, a communications bus, cross-over bar, or network) where the communication infrastructure 302 is configured to facilitate communication between various elements of the exemplary computer system 300. Various software embodiments are described in terms of this exemplary computer system. After reading this description, it will become apparent to a person of ordinary skill in the relevant art(s) how to implement the invention using other computer systems and/or computer architectures.

Exemplary computer system 300 can include a display interface 308 configured to forward graphics, text, and other data from the communication infrastructure 302 (or from a frame buffer not shown) for display on a display unit 310. The computer system 300 also includes a main memory 306, which can be random access memory (RAM), and may also include a secondary memory 312. The secondary memory 312 may include, for example, a hard disk drive 314 and/or a removable storage drive 316, representing a floppy disk drive, a magnetic tape drive, an optical disk drive, etc. The removable storage drive 316 reads from and/or writes to a removable storage unit 318 in a manner well known to those having ordinary skill in the art. The removable storage unit 318, represents, for example, a floppy disk, magnetic tape, optical disk, etc. which is read by and written to by the removable storage drive 316. As will be appreciated, the removable storage unit 318 includes a computer usable storage medium having stored therein computer software and/or data.

In exemplary embodiments, the secondary memory 312 may include other similar means for allowing computer programs or other instructions to be loaded into the computer system. Such means may include, for example, a removable storage unit 322 and an interface 320. Examples of such may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to the computer system 300.

The computer system 300 may also include a communications interface 324. The communications interface 324 allows software and data to be transferred between the computer system and external devices. Examples of the communications interface 324 may include a modem, a network interface (such as an Ethernet card), a communications port, a PCMCIA slot and card, etc. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. These propagated signals are provided to the communications interface 324 via a communications path (that is, channel) 326. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Advantages of various embodiments of the invention include dynamic group generation in a virtual environment. Other advantages of some of the other embodiments include more targeted communication within a group and communication external to the group. Although the invention explains various advantages of some specific embodiments of the invention, those skilled in the art will appreciate from the teaching of the embodiments that the advantages of the invention are not limited to the above mentioned.

The described techniques may be implemented as a method, apparatus or article of manufacture involving software, firmware, micro-code, hardware such as logic, memory and/or any combination thereof. The term “article of manufacture” as used herein refers to code or logic and memory implemented in a medium, where such medium may include hardware logic and memory [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also include transmission signals propagating through space or a transmission media, such as an optical fiber, copper wire, etc. The transmission signal in which the code or logic is encoded may further include a wireless signal, satellite transmission, radio waves, infrared signals, Bluetooth, the internet etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may include a combination of hardware and software components in which the code is embodied, processed, and executed. Of course, those skilled in the art will recognize that many modifications may be made without departing from the scope of embodiments, and that the article of manufacture may include any information bearing medium. For example, the article of manufacture includes a storage medium having stored therein instructions that when executed by a machine results in operations being performed.

Certain embodiments can take the form of an entirely hardware embodiment, an entirely software embodiment, or an embodiment containing both hardware and software elements. In a preferred embodiment, the invention is implemented in software, which includes but is not limited to firmware, resident software, microcode, etc. Elements that are in communication with each other need not be in continuous communication with each other, unless expressly specified otherwise. In addition, elements that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently. Further, some or all steps may be performed in run-time mode.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

Although exemplary embodiments of the present invention have been described in detail, it should be understood that various changes, substitutions and alternatives could be made thereto without departing from spirit and scope of the inventions as defined by the appended claims. Variations described for exemplary embodiments of the invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the present invention.

What is claimed is:

1. A computer implemented method for generating a group of users in a virtual environment, the method comprising:
identifying a pre-defined set of similarity parameters associated with a plurality of users wherein the pre-defined set of similarity parameters includes at least one non-spatial dynamic parameter; and
creating the group of users based on the identified at least one non-spatial dynamic parameter.

2. The method of claim 1, wherein the at least one non-spatial dynamic parameter is selected from a set comprising at least one from a plurality of dynamic behavior parameters, a plurality of dynamic sensor data parameters, and a plurality of dynamic message data parameters.

3. The method of claim 1, wherein the pre-defined set of similarity parameters further comprises at least one of a plurality of spatial dynamic parameters, a plurality of spatial historical parameters, and a plurality of non-spatial historical parameters.

4. The method of claim 3, wherein the plurality of spatial dynamic parameters comprises at least one of geographical coordinates, and geographical proximity with respect to a reference, and the plurality of non-spatial historical parameters comprises at least one from a plurality of client profile parameters, a plurality of client interest parameters, and a plurality of client website usage parameters.

5. The method of claim 1, further comprising:
modifying the group in response to a change in at least one parameter from a plurality of spatial dynamic parameters and the at least one non-spatial dynamic parameter.

6. The method of claim 1, further comprising:
processing the identified pre-defined set of similarity parameters using at least one from a pre-defined set of analysis tools comprising data mining, statistics, machine learning, and artificial intelligence.

7. The method of claim 6, further comprising:
generating a plurality of group characteristics associated with the group using the processing of the identified pre-defined set of similarity parameters.

8. The method of claim 7, further comprising:
providing a user interface to at least one client from the group for intragroup communication, in response to the generated plurality of group characteristics.

9. The method of claim 7, further comprising:
providing a user interface to at least one client from the group for communication external to the group, in response to the generated plurality of group characteristics.

10. A system of generating a group within a plurality of clients in a virtual environment, the system comprising at least one processor and at least one memory, wherein the processor is adapted to:
identify a pre-defined set of similarity parameters associated with the plurality of clients including at least one non-spatial dynamic parameter; and
create the group within the plurality of clients using the identified at least one non-spatial dynamic parameter.

11. The system of claim 10, wherein the at least one non-spatial dynamic parameter is selected from a set comprising at least one from a plurality of dynamic behavior parameters, a plurality of dynamic sensor data parameters, and a plurality of dynamic message data parameters.

12. The system of claim 10, wherein the pre-defined set of similarity parameters further comprises at least one of a plurality of spatial dynamic parameters, a plurality of spatial historical parameters, and a plurality of non-spatial historical parameters.

13. The system of claim 12, wherein the plurality of spatial dynamic parameters comprises at least one of geographical coordinates, and geographical proximity with respect to a reference, and the plurality of non-spatial historical parameters comprises at least one from a plurality of client profile parameters, a plurality of client interest parameters, and a plurality of client website usage parameters.

14. The system of claim 10, wherein the processor is further adapted to:
modify the group in response to a change in at least one parameter from a plurality of spatial dynamic parameters and the at least one non-spatial dynamic parameter.

15. The system of claim 10, wherein the processor is further adapted to:
process the identified pre-defined set of similarity parameters using at least one from a pre-defined set of analysis tools comprising data mining, statistics, machine learning and artificial intelligence; and
generate a plurality of group characteristics associated with the group using the processing of the identified pre-defined set of similarity parameters.

16. The system of claim 15, wherein the processor is further adapted to:
provide a user interface to at least one client from the group for communication in response to the generated plurality of group characteristics, wherein the user interface is used for at least one of intra-group communication and communication external to the group.

17. A computer program product for retrieving a subset of data from a data repository, the computer program product comprising:
a computer readable storage medium having computer readable program code embodied therewith, the computer readable program code comprising computer readable program code configured to:
identify a pre-defined set of similarity parameters associated with the plurality of clients including at least one non-spatial dynamic parameter; and
create the group within the plurality of clients using the identified at least one non-spatial dynamic parameter.

18. The computer program product of claim 17, further configured to:
modify the group in response to a change in at least one parameter from a plurality of spatial dynamic parameters and the at least one non-spatial dynamic parameter.

19. The computer program product of claim 17, further configured to:
process the identified pre-defined set of similarity parameters using at least one from a pre-defined set of analysis tools comprising data mining, statistics, machine learning and artificial intelligence; and
generate a plurality of group characteristics associated with the group using the processing of the identified pre-defined set of similarity parameters.

20. The computer program product of claim 19, further configured to:
provide a user interface to at least one client from the group for intragroup communication in response to the generated plurality of group characteristics, wherein the user interface is used for at least one of intra-group communication and communication external to the group.
